(19) United States
(12) Patent Application Publication
(10) Pub. No.: US 2011/0141246 A1
(43) Pub. Date: Jun. 16, 2011

(54) System and Method for Producing Stereoscopic Images

(76) Inventors: Justin Michael SCHWARTZ, Orlando, FL (US); Steven C. Blum, Orlando, FL (US); Robert John Cortelyou, Maitland, FL (US); Thierry Coup, Orlando, FL (US); Brian Birney McQuillian, Orlando, FL (US)

(21) Appl. No.: 12/846,301

(22) Filed: Jul. 29, 2010

Related U.S. Application Data
(60) Provisional application No. 61/286,469, filed on Dec. 15, 2009.

(51) Int. Cl. H04N 13/04

(52) U.S. Cl. 348/53; 348/E13.075

(57) ABSTRACT

A system and method for displaying a stereoscopic image to a guest that compensates for spatial orientation of the guest includes providing a guest with a device comprising eye lenses, projecting a first and a second image on a surface viewable by the guest, wherein the first image has a polarizing vector that is orthogonal to a polarization vector of the second image, varying the rotational and translational orientation of the guest relative to the surface viewable by the guest, maintaining a directional correspondence between the polarizing vector for the one eye lens and that of the first image and the other eye lens and that of the second image during changes in the guest rotational and translational orientation to reduce distortion in the images viewed by the guest.

### CROSS-REFERENCE TO RELATED APPLICATION

This application is related to and claims the benefit of U.S. Provisional Application No. 61/286,469, filed Dec. 15, 2009 and titled SYSTEM AND METHOD FOR PRODUCING STEREOSCOPIC IMAGES, which is hereby incorporated by reference in its entirety for all purposes.

### BACKGROUND

The present invention relates to stereoscopic imagery and method of producing the same. More particularly, the present invention relates to a device and method for producing stereoscopic images for viewers who are dynamically and randomly oriented.

Stereoscopic imaging is any technique capable of recording three-dimensional (hereinafter “3D”) visual information or creating the illusion of depth in an image. The stereoscopic method is classified into an anaglyph method that involves wearing spectacles having blue and red lenses on respective sides, a polarization method that involves wearing of polarizing spectacles having different polarization directions for each lens, and a time-division method that involves wearing of spectacles including an electronic shutter synchronized with intervals by which a frame is repeated time-divisionally presented such that the wearer's right eye sees only right eye images and left eye sees only left eye images, the opposite eye being blocked with an opaque lens when the electronic shutter is “on”.

Ride and simulation systems, and most particularly those systems incorporating motion base or simulator technology may orient the rider or participant randomly along as many as three orthogonal linear and three orthogonal rotational axes. It is common practice to incorporate a visual display device in such systems. It is furthermore common practice to employ such projection or display devices, or both in a stereoscopic (3-D) configuration. One common method of obtaining stereoscopic imaging is to employ separate left and right eye image sources, and to orthogonally polarize the light of such images as it approaches the observer. The observer wears glasses including polarized filters intended to filter the left eye image from the right eye's field of view, and similarly the right eye's image from the left eye's field of view. When said display device is not carried on the ride or simulation system, and is consequently not matched in orientation to the orientation of the observer, this orthogonal polarization and filtering technique is substantially degraded, and the resulting stereoscopic effect is lost.

The polarization method, also known as the linear polarization method, includes two images projected and superimposed onto the same screen through orthogonal polarizing filters. Generally, a silver screen is used so that polarization is preserved. The projectors can receive their outputs from a computer with a dual-head graphics card. The viewer typically wears low-cost eyeglasses which also contain a pair of orthogonal polarizing filters. As each filter only passes light which is similarly polarized and blocks the orthogonally polarized light, each eye only sees one of the images, and the effect is achieved. However, current linearly polarized glasses require the viewer to keep his head level, as tilting of the viewing filters will cause the images of the left and right channels to bleed over to the opposite channel.

For example, U.S. Pat. No. 4,744,633 describes an optical system to permit viewing of adjacent stereoscopic images in which the observers each wear a pair of eyeglasses to view the display. Polarizing light filters are positioned in front of each of the stereoscopic images and these filters have different angles of polarization to encode each image. Each eyepiece includes a polarized filter which decodes the image for its respective eye, and a rotatably adjustable prism which deviates the line of sight a sufficient degree that both stereoscopic images are fused in the fovea of the eye. The rotatably adjustable prism can be a solid prism or a Fresnel prism. The rotation of the prism permits the observer to adjust the refractory angle of the image regardless of the observer's distance to the image source, and thus permits the observer to move about the displayed images and permits a plurality of observers to view the display. These systems do not have a sufficient field of view, and do not correct for changes in roll angle, which may defined as the rotational position about an axis that approximately extends from the observer's eye point to the image of interest on the screen or display. However, attempts have been made to rectify the field of view problem.

In another example, U.S. Pat. No. 5,854,706 describes a pair of adjacent image displaying means to generate a stereoscopic pair of images. A semitransparent mirror and two polarizing filters merge the two images in the same virtual space and impart distinctive polarization to light rays carrying the two images displayed. A louver type filter suppresses the residual view generated by one of the displaying means. The louvers will allow only the image reflected on said semitransparent mirror to pass. A second louver type filter compensates the attenuation that the first louver type filter has introduced, in such a way that the two combined images are of adequately similar intensity. A user wearing polarizing spectacles can see a stereoscopic image from a variety of azimuths, however, this approach does not correct for changes in roll angle (rotational position about an axis that roughly extends from the observer's eye point to the image of interest on the screen or display).

Thus, past devices, systems and methods such as those described above do not provide adequately undistorted images when observers are dynamically moved with respect to the display screen.

### BRIEF DESCRIPTION OF THE INVENTION

Accordingly, there is a desire for a stereoscopic imaging system and method for a viewer or a group of viewers that are dynamically and randomly oriented with respect to a viewing surface. As such, the present disclosure describes a system and method for producing a stereoscopic image.

In a first embodiment, the invention provides a method for displaying a stereoscopic image to a guest that compensates for spatial orientation of the guest, the method comprising the steps of providing a guest with a device comprising eye lenses, each eye lens having a filter that has a polarizing vector that is orthogonal to the other whereby each eye lens has a correspondingly configured low extinction coefficient and an opposingly configured high extinction coefficient to reduce passage of light polarized to pass through the other lens, projecting a first and a second image on a surface viewable by the guest, wherein the first image has a polarizing vector that is orthogonal to a polarization vector of the second image, varying the rotational and translational orientation of the guest relative to the surface viewable by the guest and maintaining a directional correspondence between the polarizing vector for the one eye lens and that of the first image and the other eye lens and that of the second image during changes in the guest rotational and translational orientation to reduce distortion in the images viewed by the guest.

In a another embodiment, the invention provides a system for displaying a stereoscopic image to a guest that compensates for spatial orientation of the guest, the system comprising headwear comprising eye lenses, each eye lens having a filter that has a polarizing vector that is orthogonal to the other whereby each of the eye lenses has a correspondingly configured low extinction coefficient and an opposingly configured high extinction coefficient to reduce passage of light polarized to pass through the other lens, an image producing device configured to project a first and second image on a surface viewable by a guest, wherein the first image has a polarizing vector that is orthogonal to a polarizing vector of the second image, a guest path configured to vary the rotational and translational orientation of a guest relative to the surface viewable by the guest, wherein a directional correspondence between the polarizing vector for the one eye lens and that of the first image and the other eye lens and that of the second image during changes in the guest rotational and translational orientation are maintained to reduce distortion in the images viewed by the guest.

In another embodiment, a system for displaying a stereoscopic image to a guest on a path that compensates for spatial orientation of a guest, the system comprising, a direct-view device viewable by the guest, at least one strobed orthogonal polarizing filter proximate the direct-view device, wherein the at least one strobe orthogonal polarizing filter is configured to rotate to correspond to guest rotational and translational orientation to reduce distortion on the images viewed by the guest when viewed through three dimensional glasses.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1 is a perspective view of an amusement ride incorporating a method of compensating for point of view image distortion for a 3D stereoscopic projection.

FIG. 2 is a perspective view of the amusement park ride of FIG. 1, incorporating a method that compensates for spatial orientation of the guest.

FIG. 3 is a front view of the system for producing stereoscopic images during a theme park attraction to which embodiments of the present invention relate.

FIG. 4 is a back view of a stereoscopic imaging system in which the guest has changed orientation with respect to the viewing screen.

FIG. 5 is a flow chart describing a step-wise method in accordance with a further embodiment of the present invention.

Like reference characters designate identical or corresponding components and units throughout the several views, which are not to scale unless otherwise indicated.

### DETAILED DESCRIPTION

One embodiment of the present invention involves a system and method produces a stereoscopic image that compensates for spatial orientation of the guest. One particular advantage afforded by this invention is that it greatly enhances the realism of stereoscopic imagery in an amusement ride in which guests are randomly and dynamically oriented with respect to a viewing surface. Another advantage afforded by this invention is the ability to track a guest's orientation in real-time and adjust the stereoscopic image accordingly.

Specific configurations and arrangements of the claimed invention, discussed below with reference to the accompanying drawings, are for illustrative purposes only. Other configurations and arrangements that are within the purview of a skilled artisan can be made, used, or sold without departing from the spirit and scope of the appended claims. For example, while some embodiments of the invention are herein described with reference to a theme park, a skilled artisan will recognize that embodiments of the invention can be implemented at water parks and the like.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features. As used herein, non-limiting examples of a “theme park attraction” may comprise a rollercoaster type vehicle, a log flume, or virtual reality shows and the like. Please note, as used herein, the terms “attraction” and “ride” are use interchangeably. Furthermore, as used herein, the terms “roll”, “pitch” and “yaw’ may refer to typical Tait-Bryan angles most often associated with flight dynamics. The terms “roll, pitch and yaw” may also be referred to as “the rotational and translational axes”.

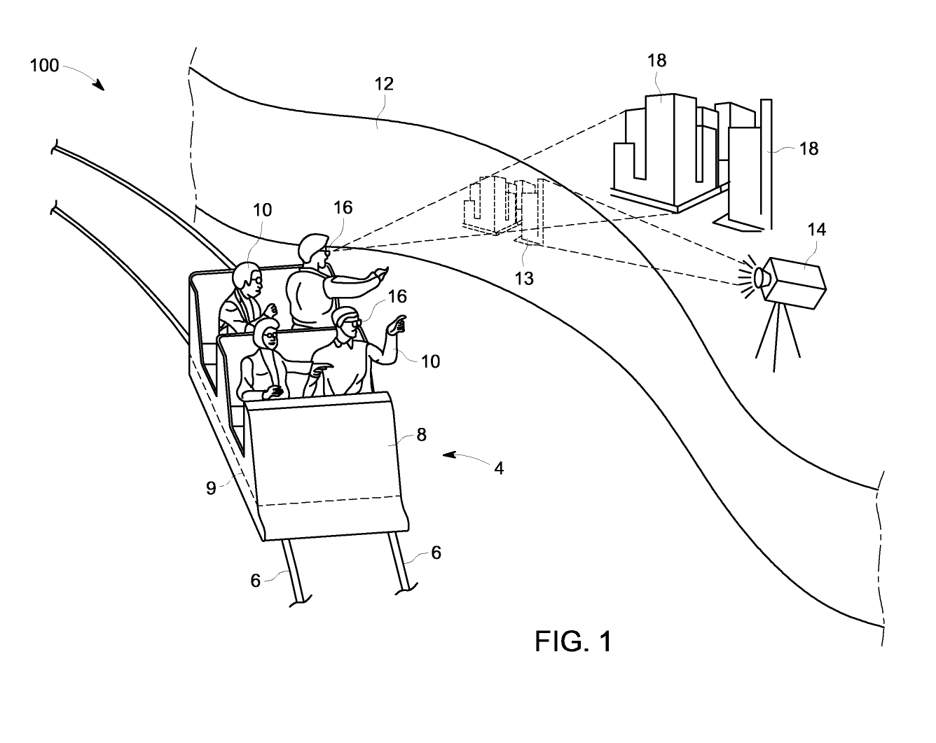

Referring now to FIG. 1, an amusement park ride incorporating a system for producing a stereoscopic image is shown generally at reference numeral 100. The amusement ride 4 includes a track 6. A vehicle 8 is located on the track 6 and includes seating for passengers or guests 10. The vehicle 8 has wheels or other means for moving along the track 6. During the amusement ride 4 the vehicle 8 containing passengers 10 travels along the track 6 giving the passengers 10 a moving tour of the scenery around them. The track 6 thus defines the motion of the vehicle 8 and the passengers 10 residing therein. In an alternative embodiment, the track 6 is replaced by a controlled path with the vehicles movement controlled via electronic, computer, or other means, rather than by the track. The vehicle 8 may also include a motion base 9, to provide additional degrees of movement.

Located outside the vehicle 8 are a plurality of projection surfaces 12. There can be any number of projection surfaces 12 throughout the amusement ride 4. The projection surfaces 12 can be any shape, including flat or curved depending on the desired visual effect that will be imparted on the passengers 10.

A projector or a plurality of projectors 14 project images 13 onto the projection surfaces 12. When a plurality of projection surfaces 12 are employed, a separate projector 14 is used for each projection surface 12. In the embodiment shown, the projector 14 is a rear projector 14, wherein the projector 14 is located behind the projecting surface 12, i.e., opposite to where the passengers 10 are located. However, the invention is useful with any projection method, front or rear.

As shown in FIG. 1, the passengers 10 of the vehicle 8 preferably wear 3D stereoscopic glasses 16. The 3D glasses are worn throughout the duration of the ride, give the passengers 10 the impression of a “virtual world” surrounding them. Still referring to FIG. 1, passengers 10 are shown watching the projected images 13 on a single projection surface 12. The illusion created by this amusement ride 4 permits the passengers 10 to see virtual images 18 that appear to project and jut towards them through the projection surface 12.

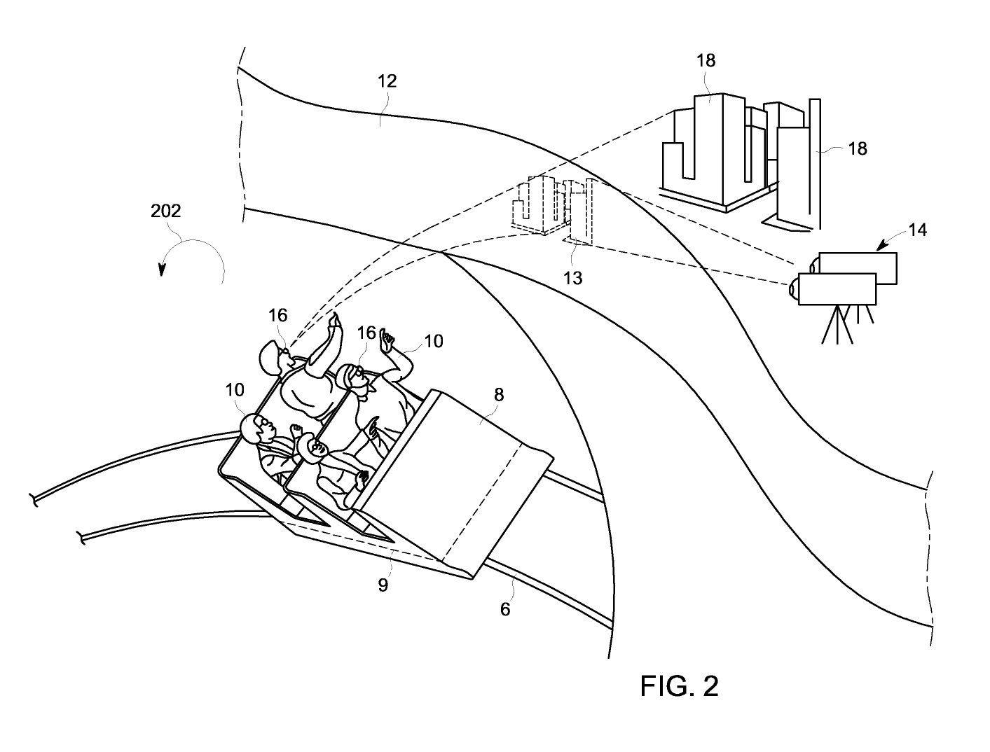

Now with reference to FIG. 2, an amusement park ride incorporating a system for producing a stereoscopic image is shown generally at reference numeral 200. While as in FIG. 1, the amusement ride comprises a vehicle 8 located on the track 6 including seating for passengers or guests 10, in this particular embodiment, the vehicle 8 has rolled as shown by arrow 202, so that guest, is now viewing the image from a different spatial orientation. In past stereoscopic image producing systems, when the orientation of a guest changes due to changes in roll, pitch and yaw, the stereoscopic image is distorted or eliminated entirely.

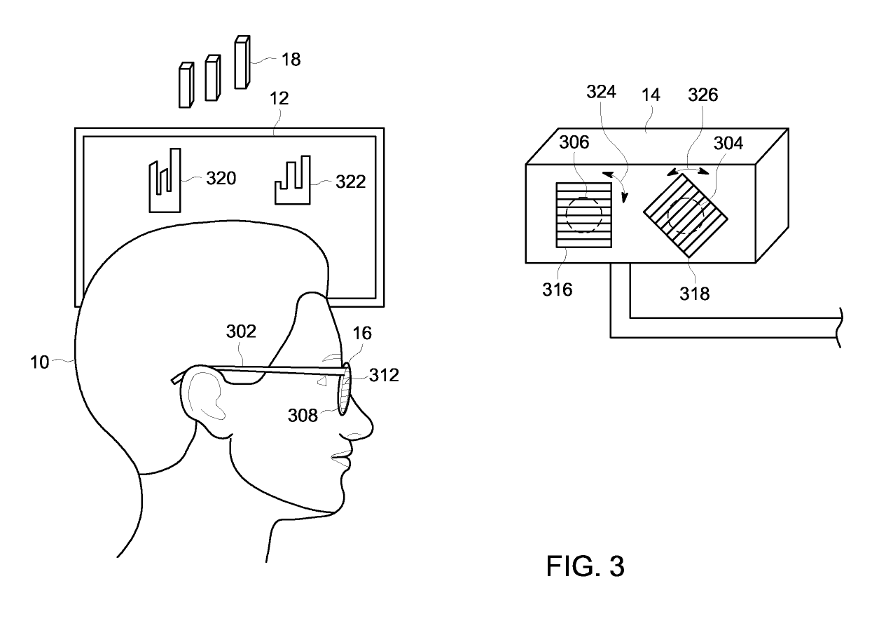

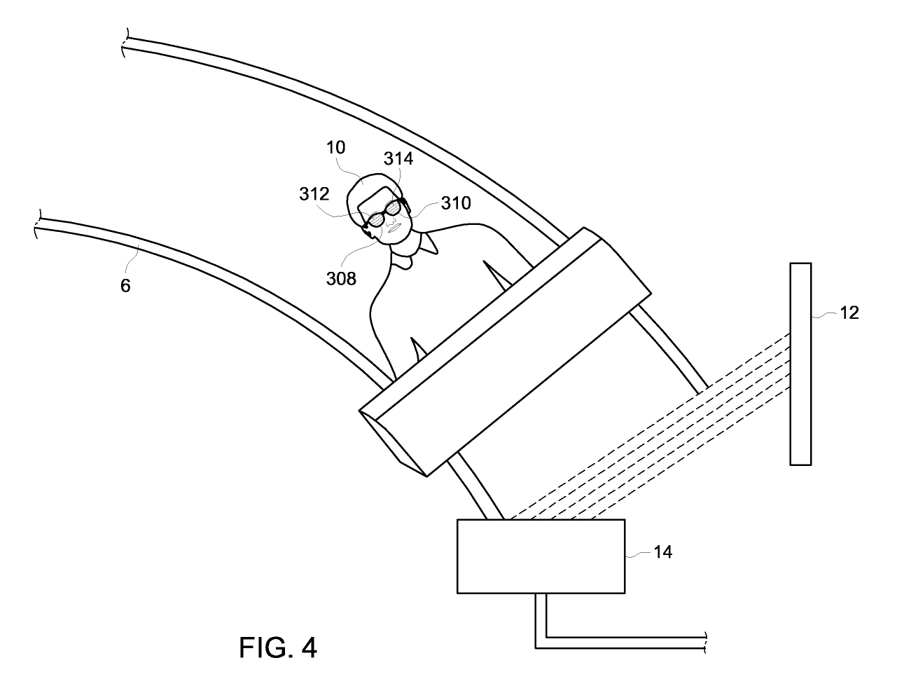

In an exemplary embodiment of the present invention, as shown with reference to FIGS. 3 and 4, a system for displaying a stereoscopic image to a guest that compensates for spatial orientation or the guest, and in particular, roll pitch and yaw of the guest. The system may comprise headwear 302, an image producing device 14 having two image projectors 304 and 306, and a guest path (shown in FIG. 1 at reference numeral 6).

In this exemplary embodiment, the headwear may comprise glasses 16 comprising a first eye lens 308 and second eye lens 310. Each eye lens 308 and 310 may comprise a filter 312, 314 that has a polarizing vector that is orthogonal to the other whereby each of the lenses has a correspondingly configured low extinction coefficient and an on opposingly configured high extinction coefficient to reduce passage of light polarized to pass through the other lens. For example, if the guest is upright, having a 0 degree pitch, the filters 312 and 314 may be 0 and 90 degrees respectively. However, as the ride path is altered, and the pitch or roll of the guest changes, and therefore, the polarization vectors of the filters must also be altered. They will, however, remain orthogonal in that if the guest rolls 30 degrees, the filters will have polarizing vectors of 30 and 120 degrees, respectively rather than the 0 and 90 degrees they originally had. While in known stereoscopic imaging systems, this proves fatal to the image; the present system describes an image producing device which is configured to track the orientation of the guest and reorient respective stereo image eye points to correspond to the guests orientation, as will be explained in greater detail below.

The image producing device 14 may comprise a first and second image projectors 304 and 306. Each image projector 304 and 306 may be a front or rear projector to project right and left images 320 and 322 on a surface 12 viewable by a guest, wherein the first image projecting device 304 has a polarizing vector that is orthogonal to a polarizing vector of a second image projecting device 306. For example, in an exemplary embodiment of the present invention, two image projecting devices 304 and 306, each having a polarizing filter, referred to as left and right polarizing filters 316 and 318, which correspond to the right and left eye polarizing filters 312 and 314 on the first and second eye lenses 308 and 310 of the headwear 302. As such, the right and left eye polarizing filters 312 and 314 of the headwear 302, together with the left and right polarizing filters 316 and 318 of the projection devices 304 and 306 are configured to provide a low extinction coefficient within the right eye lens 308 of the headwear 302 for the first image 320, a high extinction coefficient within the right eye lens 308 of the headwear 302 for the second image 322, and conversely, a high extinction coefficient within the left eye lens of the headwear 302 for the first image 320, a low extinction coefficient within the left eye lens of the headwear for the second image 322, such that the viewer sees the first and second images 320 and 322 principally in only the corresponding eye.

Referring back to FIG. 1 and referring further to FIG. 3, a guest path 6 is provided and configured to vary the rotational and translational orientation (e.g., roll, pitch, and yaw) of the guest relative to the surface 12 viewable by the guest 10. As the guest 10 changes his or her orientation, a directional correspondence between the polarizing vector for the one eye lens and that of the first image and the other eye lens and that of the second image during changes in the guest rotational and translational orientation so that the orientation is seemingly maintained, which reduces distortion in the images viewed by the guest. In this way, during the amusement ride 4, when the passengers are traveling in the vehicle 8, the 3D virtual images 18 appear to be a seamless three-dimensional picture of the surrounding scenery.

With reference back to FIG. 3, the image sources 304 and 306 are configured to dynamically alter the relative eye point for the left and right image 320 and 322 to correspond to the dynamic spatial orientation (rotational and translational position) of the guests, such that the image polarizing filters 316 and 318 are configured to dynamically alter their polarizing axes such that the aforementioned extinction characteristics are maintained at the observer's polarized headwear 302. Each of the first and second filters 316 and 318 may be rotatable around an axis as shown by arrows 324 and 326. For example, the filters 316, 318 at the source can be rotated and/or translated in response to a predetermined programmed motion profile that the ride is executing, the filters in the glasses can be rotated similarly, so that all three rotational axes are modulated. This type of modulation can be done open loop, with each device 14 having a program that it executes without communication to the other systems or feedback on whether it is responding to the command as planned, or closed loop, where the device 14 self-verifies that it is on its programmed path, and may receive real time information from other devices confirming what position it should be in). If the motion profile is not pre-programmed, then the filters 316 and 318 can be modulated in response to either the motion input commands (e.g., input by the guest or operator), or the filters can be modulated in response to a feedback signal from the system from, for example, position transducers, including, but not limited to encoders, string potentiometers, linear voltage differential transducers, Pohlhausen sensors, and the like. In optional embodiments of the present invention, the image projecting device 14 may be configured to dynamically reorienting the polarization vector either together with or separate from the polarizing filters 316 and 318 to allow random orientation changes for observers of stereo images.

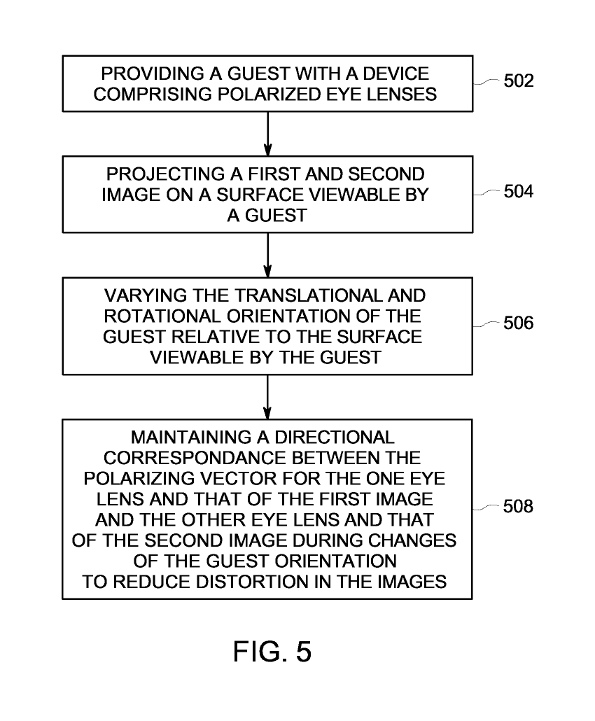

Referring now to FIG. 5, there is shown a flow chart to better help illustrate a method for displaying a stereoscopic image to a guest that compensates for spatial orientation of the guest. While the flowchart shows an exemplary step-by-step method, it is to be appreciated that a skilled artisan may rearrange or reorder the steps while maintaining like results.

Providing a guest with a device comprising eye lenses step 502 may comprise providing a guest with headwear, such as glasses having an two eye lenses, each having a filter that has a polarizing vector that is orthogonal to the other, whereby each eye lens has a correspondingly configured low extinction coefficient and an opposingly configured high extinction coefficient to reduce passage of light polarized to pass through the other lens when viewing the image produced by the images projecting device.

Projecting a first and a second image on a surface viewable by the guest step 504 may comprise projecting a first image having a polarizing vector that is orthogonal to a polarization vector of the second image. For example, if the first image is projected onto the surface with a polarizing vector of 0 degrees, the second image may then be projected onto the surface having a polarizing vector or 90 degrees. The polarizing vectors are configured to vary with respect to the orientation of the guest, but will however remain approximately orthogonal in relation to the other. For example, as the guest changes his or her translational and rotational orientation, via movement down a track, the polarizing vectors may reorient to 30 degrees and 120 degrees, respectively.

Varying the rotational and translational orientation of the guest relative to the surface viewable by the guest, step 506, may comprise providing a vehicle 8 having a motion base such that the view point may move in pitch, roll, yaw, heave, surge and sway, as generated by the motion base, in addition to the track generated movements. In one embodiment of the present invention, these movements may be predetermined so that the eye points can be reoriented at predetermined intervals. In an optional embodiment, guest orientation may be tracked in real-time and the eye points reoriented in real-time accordingly.

Maintaining a directional correspondence between the polarizing vector for the one eye lens and that of the first image and the other eye lens and that of the second image during changes in the guest rotational and translational orientation to reduce distortion in the images viewed by the guest, step 508, may comprise reorienting the polarization filter, and thus the polarization vector of the image projectors to maintain the extinction coefficients at the at the polarized lenses of the guests headwear by altering an eye point of a first and second image to correspond to the orientation of the guest. For example, as described with reference to FIGS. 3 and 4, the method may comprise providing two image projecting devices 304 and 306, each having a polarizing filter, referred to as left and right polarizing filters 316 and 318, which correspond to the right and left eye polarizing filters 312 and 314 of the headwear 302. As such, the right and left eye polarizing filters 312 and 314 of the headwear 302, together with the left and right polarizing filters 316 and 318 of the projection devices 304 and 306 are configured to provide a low extinction coefficient within the right eye lens 308 of the headwear 302 for the first image 320, a high extinction coefficient within the right eye lens 308 of the headwear 302 for the second image 322, and conversely, a high extinction coefficient within the left eye lens of the headwear 302 for the first image 320, a low extinction coefficient within the left eye lens of the headwear for the second image 322, such that the viewer sees the first and second images 320 and 322 principally in only the corresponding eye.

In operation, a 3-D simulator ride in which guests move about a track in a vehicle, it may be desirable to vary the translational and rotational orientation of the guest (e.g., the roll, pitch and yaw) to provide a more thrilling experience. However, changing the roll, for example, distorts the image and makes the image look much less realistic. However, because the track has a known axis of rotation and translation throughout, plurality of image projecting device may be set around the track, and their filters may rotate to maintain the extinction characteristics in the polarized headwear, thus maintaining the realistic 3-D image. Thus, for example, if a roll of 20 degrees occurs at the track level, the polarizing filters of the image projectors reorient to account for the 20 degree shift. As the track shifts back to 0 degrees, the image projecting devices shift their filters accordingly.

Optionally, in a 3-D simulator experience in which the guests are free to roam about an area, each guest must be tracked in real time and their orientation accounted for by the image projecting devices. Guest tracking may be accomplished in several ways including, but not limited to the following: Guests may be individually outfitted with a Pohlhausen sensing device; guests may be observed with one or more video cameras, the images being post-processed with facial recognition software; or the glasses 302 may be provided to the guest includes trajectory sensing devices such as accelerometers and/or ring laser or mechanical gyroscopes. These systems provide feedback to detect both guest orientation and the position of their eye points in 3-D space. Stereoscopic filter orientation may controlled utilizing this data. For individual visual experiences or experiences where a group is expected to be in a relatively uniform orientation, the source filtering can be modulated. In a system where random guest positioning per guest is possible, the modulation may be at the individual guest headset.

In another optional embodiment of the present invention, an image-viewing device may comprise a direct-view device such as LCD or plasma display. In this embodiment, the direct-view device is both an image-producing device and an image-viewing device. The direct-view device may include strobed orthogonal polarizing filters which are active at the device, that is rotate to correspond to guest motion, but passive at the user. For example, in this embodiment, a guest may wear 3D glasses that are known in the art. The strobed filters are configured to correspond to the dynamic spatial orientation (rotational and translational position) of the guests, such that the strobed polarizing filters are configured to dynamically alter their polarizing axes such that the aforementioned extinction characteristics are maintained at the observer's polarized headwear 302. Each of the strobed filters may be rotatable around an axis as described with reference to FIG. 3. For example, the filters disposed at the screen can be rotated and/or translated in response to a predetermined programmed motion profile that the ride is executing, the filters can be rotated similarly, so that all three rotational axes are modulated. This type of modulation can be done open loop or closed loop and in real-time, as explained with reference to FIG. 3.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only, possible embodiments. Rather, modifications and other embodiments are intended to be included within the scope of the appended claims.

What is claimed is:

1. A method for displaying a stereoscopic image to a guest that compensates for spatial orientation of the guest, the method comprising the steps of:
providing a guest with a device comprising eye lenses, each eye lens having a filter that has a polarizing vector that is orthogonal to the other whereby each eye lens has a correspondingly configured low extinction coefficient and an opposingly configured high extinction coefficient to reduce passage of light polarized to pass through the other lens;
projecting a first and a second image on a surface viewable by the guest, wherein the first image has a polarizing vector that is orthogonal to a polarization vector of the second image;
varying the rotational and translational orientation of the guest relative to the surface viewable by the guest;
maintaining a directional correspondence between the polarizing vector for the one eye lens and that of the first image and the other eye lens and that of the second image during changes in the guest rotational and translational orientation to reduce distortion in the images viewed by the guest.

2. The method of claim 1, further comprising altering an eye point of the first and second images to correspond to the orientation of the guest.

3. The method of claim 1, wherein maintaining a directional correspondence between the polarizing vector for the one eye lens and that of the first image and the other eye lens and that of the second image comprises rotating a left and right polarization filter disposed on a projector to correspond to the rotational changes in the orientation of the guest, or rotating the eye lens filters to correspond to the orientation of the guest, wherein three rotational axes are maintained.

4. The method of claim 1, wherein projecting a first and a second image on a surface viewable by the guest comprises providing an image producing device having a left and right image projector, each image projector comprising left and right polarization filters movable around a rotational axis.

5. The method of claim 1, wherein maintaining the directional correspondence between the polarizing vector for the one eye lens and that of the first image and the other eye lens and that of the second image comprises rotating a right and left polarization filter of the image projectors of the one eye lens and the other eye lens to match the polarizing vector direction of the first image and the polarizing vector direction of the second image.

6. The method of claim 1, wherein varying the rotational and translational orientation of the guest relative to the surface viewable by the guest comprises providing a track or path with a known orientation, in which the track provides varying degrees of roll, pitch and yaw at different predetermined positions.

7. The method of claim 1, further comprises tracking the guests in real-time, wherein tracking the guest comprises providing sensors in communication with the left and right polarizing filters on the image projecting device, wherein the filters are configured to rotate in response to guest motion.

8. A system for displaying a stereoscopic image to a guest that compensates for spatial orientation of the guest, the system comprising:
headwear comprising eye lenses, each eye lens having a filter that has a polarizing vector that is orthogonal to the other whereby each of the eye lenses has a correspondingly configured low extinction coefficient and an opposingly configured high extinction coefficient to reduce passage of light polarized to pass through the other lens;
an image producing device configured to project a first and second image on a surface viewable by a guest, wherein the first image has a polarizing vector that is orthogonal to a polarizing vector of the second image;
a guest path configured to vary the rotational and translational orientation of a guest relative to the surface viewable by the guest;
wherein a directional correspondence between the polarizing vector for the one eye lens and that of the first image and the other eye lens and that of the second image during changes in the guest rotational and translational orientation are maintained to reduce distortion in the images viewed by the guest.

9. The system of claim 8, wherein the image producing device is further configure to alter an eye point of the first and second images to correspond to the orientation of the guest.

10. The system of claim 8, further comprising a left and right image projector, each image projector comprising left and right polarization filters movable around a rotational axis.

11. The system of claim 8, wherein the image producing device is further configured to rotate the polarization of the first image and the second image to match the rotational changes in the orientation of the guest to maintain a directional correspondence between the polarizing vector for the one eye lens and that of the first image and the other eye lend and that of the second image.

12. The system of claim 8, wherein the each of the left and right polarization filters are configured to maintain the directional correspondence between the polarizing vector for the one eye lens and that of the first image and the other eye lens and that of the second image by rotating the polarization of the one eye lens and the other eye lens to match the polarizing vector direction of the first image and the polarizing vector direction of the second image.

13. The system of claim 8, wherein the guest path comprises a track or path with a known orientation, in which the track provides varying degrees of roll, pitch and yaw at different predetermined positions.

14. The system of claim 8, further comprising a plurality of sensors in communication with the left and right polarizing filters on the image projecting device, wherein the filters are configured to rotate in response to guest motion.

15. A system for displaying a stereoscopic image to a guest on a path that compensates for spatial orientation of a guest, the system comprising:
a direct-view device viewable by the guest;
at least one strobed orthogonal polarizing filter proximate the direct-view device;
wherein the at least one strobe orthogonal polarizing filter is configured to rotate to correspond to guest rotational and translational orientation to reduce distortion on the images viewed by the guest when viewed through three dimensional glasses.

16. The system of claim 15, wherein the guest path comprises a track or path with a known orientation, in which the track provides varying degrees of roll, pitch and yaw at different predetermined positions.

17. The system of claim 15, further comprising a plurality of sensors in communication with the strobed orthogonal polarizing filters on the direct-view device, wherein the filters are configured to rotate in response to guest movement.
